(19) United States
(12) Patent Application Publication
(10) Pub. No.: US 2019/0030741 A1
(43) Pub. Date: Jan. 31, 2019

(54) CUTTING DEVICE AND CUTTING METHOD

(71) Applicant: WUHAN CHINA STAR OPTOELECTRONICS SEMICONDUCTOR DISPLAY TECHNOLOGY CO., LTD., Wuhan, Hubei (CN)

(72) Inventors: Xiao DU, Wuhan (CN); Qian JIANG, Wuhan (CN); Junying MU, Wuhan (CN); Jing NI, Wuhan (CN)

(21) Appl. No.: 15/737,657

(22) PCT Filed: Sep. 6, 2017
(86) PCT No.: PCT/CN2017/100693

§ 371 Date: Dec. 18, 2017

(30) Foreign Application Priority Data
Jul. 25, 2017 (CN) 201710611828.4

(51) Int. Cl. B26D 3/28; B26D 7/26; C03B 33/07; C03B 33/03

(52) U.S. Cl. CPC B26D 3/282; B26D 7/2614; C03B 33/03; C03B 33/074; B26D 7/2628

(57) ABSTRACT

A cutting device and a cutting method are provided. The cutting device includes a cutting platform, a cutting blade assembly, a peeling device, and a cutter wheel. The cutting blade assembly, the peeling device, and the cutter wheel are disposed above the cutting platform and are sequentially disposed from right to left. The cutting platform is configured to support a flexible substrate. The cutting blade assembly is configured to cut a flexible material layer. The peeling device is configured to peel off a cutted flexible material layer from the glass substrate. The cutter wheel is configured to form a cutting mark on the glass substrate exposed outside after peeling of the flexible material layer.

### FIELD OF THE INVENTION

The present disclosure relates to the field of display technologies, and more particularly to a cutting device and a cutting method.

### BACKGROUND OF THE INVENTION

Flexible display devices refer to display devices fabricated on flexible substrates. Flexible display devices are ultra-light, ultra-thin, flexible, deformable, and easy to carry, etc. Sizes of panels of mobile terminals are getting bigger, flexible display devices in the future portable products and display technologies have a broad application and market potential.

In a manufacturing process of a flexible display device, since a manufacturing process of a display device is difficult to be fabricated on a surface of a single flexible substrate due to deformation, wrinkling, and positional deflection of the flexible substrate, the conventional manufacturing process is usually performed using a glass substrate as a rigid substrate supporter under the flexible substrate. A flexible material layer is coated on the rigid substrate as a flexible substrate, and a flexible display panel is fabricated using each process sequentially. Cutting technologies used in the display devices include wheel cutting and laser cutting.

Wheel cutting is a conventional cutting method of a glass substrate. The cutter wheel usually made of high hardness material is used as a main cutting part. A cutting process is divided into two processes including a scribing process and a breaking process. As the hardness of the cutter wheel is much greater than the hardness of glass, in scribing process, a pressure applied to the head of the cutter wheel such that the cutter wheel forms a cutting mark on the glass. However, when the glass substrate covered with a flexible material layer is being cut, a blade with an obtuse angle of the cutter wheel cannot effectively perform the cutting of the flexible material layer, that is, the flexible material layer cannot completely cut apart on the glass substrate during the cutting process. A cutter wheel with high permeability and multi-tooth number is used to cut the flexible material layer on the glass substrate, because of the flexibility of the flexible material layer, edges of products cut by the cutter wheel appear to be irregular. In the grinding process after cutting process, the flexible material layer appears cracks due to a grinding wheel and an irregular part of the edge of the flexible material layer are involved with each other. The laser cutting has high precision and high efficiency, etc., however, a production process of a flexible panel still need to do a lot of work using laser cutting due to expensive equipments, the process complexity and a heat effect, etc.

Therefore, it is necessary to provide a cutting device and a cutting method to solve the problems existing in the conventional technologies.

### SUMMARY OF THE INVENTION

An object of the present disclosure is to provide a cutting device and a cutting method capable of completely cutting a flexible material layer from a glass substrate, and the flexible material layer does not crack in the subsequent grinding process, and the processes are simple and economical.

To achieve the above object, an embodiment of the present disclosure provides a cutting device configured to cut a flexible substrate, the flexible substrate including a glass substrate and a flexible material layer disposed on the glass substrate, the cutting device including:

a cutting platform configured to support the flexible substrate;

a cutting blade assembly configured to cut the flexible material layer, the cutting blade assembly including two cutting blade groups opposite to each other, each of the cutting blade groups including a blade holder and a blade connected to the blade holder;

a peeling device configured to peel off a cutted flexible material layer from the glass substrate, the peeling device including a roller and a conveyor belt disposed on the roller, the roller configured to roll on the flexible material layer such that the flexible material layer is peeled off from the glass substrate by the conveyor belt; and

a cutter wheel configured to form a cutting mark on the glass substrate exposed outside after peeling of the flexible material layer;

wherein the cutting blade assembly, the peeling device, and the cutter wheel are disposed above the cutting platform and are sequentially disposed from right to left.

In the cutting device of an embodiment of the present disclosure, a cylinder is pressed into the blade holder such that the blade is pressed into the flexible material layer.

In the cutting device of an embodiment of the present disclosure, the blade holder is connected to the blade via a connecting part, the connecting part is operable to adjust a position of the blade on the blade holder such that a gap between the two blades is adjustable, the connecting part is further operable to adjust an angle between the blade and the blade holder such that an angle between the blade and the flexible substrate is adjustable.

In the cutting device of an embodiment of the present disclosure, the gap between the two blades ranges between 0.5 mm to 2 mm.

In the cutting device of an embodiment of the present disclosure, the angle between the blade and the flexible substrate is an acute angle.

In the cutting device of an embodiment of the present disclosure, the roller and the conveyor belt include viscous material.

An embodiment of the present disclosure further provides a cutting device configured to cut a flexible substrate, the flexible substrate including a glass substrate and a flexible material layer disposed on the glass substrate, the cutting device including:

a cutting platform configured to support the flexible substrate;

a cutting blade assembly configured to cut the flexible material layer;

a peeling device configured to peel off a cutted flexible material layer from the glass substrate; and

a cutter wheel configured to form a cutting mark on the glass substrate exposed outside after peeling of the flexible material layer;

wherein the cutting blade assembly, the peeling device, and the cutter wheel are disposed above the cutting platform and are sequentially disposed from right to left.

In the cutting device of an embodiment of the present disclosure, the cutting blade assembly includes two cutting blade groups opposite to each other, each of the cutting blade groups includes a blade holder and a blade connected to the blade holder.

In the cutting device of an embodiment of the present disclosure, a cylinder is pressed into the blade holder such that the blade is pressed into the flexible material layer.

In the cutting device of an embodiment of the present disclosure, the blade holder is connected to the blade via a connecting part, the connecting part is operable to adjust a position of the blade on the blade holder such that a gap between the two blades is adjustable, the connecting part is further operable to adjust an angle between the blade and the blade holder such that an angle between the blade and the flexible substrate is adjustable.

In the cutting device of an embodiment of the present disclosure, the gap between the two blades ranges between 0.5 mm to 2 mm.

In the cutting device of an embodiment of the present disclosure, the angle between the blade and the flexible substrate is an acute angle.

In the cutting device of an embodiment of the present disclosure, the peeling device includes a roller and a conveyor belt disposed on the roller, the roller is configured to roll on the flexible material layer such that the flexible material layer is peeled off from the glass substrate by the conveyor belt.

In the cutting device of an embodiment of the present disclosure, the roller and the conveyor belt include viscous material.

To achieve the above object, an embodiment of the present disclosure provides a cutting method, which includes:

providing a flexible substrate on a cutting platform, the flexible substrate including a glass substrate and a flexible material layer disposed on the glass substrate;

cutting the flexible substrate;

peeling off the flexible material layer from the glass substrate after cutting the flexible material; and

forming a cutting mark on the glass substrate exposed outside.

The cutting device and the cutting method of the embodiments of the present disclosure are provided by cutting the flexible material layer using the cutting blade assembly. The gap between the two blades is adjustable and the angle between the blade and the flexible material layer is adjustable such that it is easy to cut the flexible material layer and the angle between the blade and the flexible material layer is an acute angle for preventing the flexible material layer from coming into contact with a groove of a grinding wheel in the further grinding process, and damage to the flexible material layer caused by the grinding wheel in the grinding process is reduced.

The technical solution of the present disclosure will be apparent from the following detailed description of embodiments of the present disclosure, with reference to the attached drawings.

### DESCRIPTION OF THE DRAWINGS

The technical solution and the beneficial effects of the present disclosure are understood from the following detailed description with reference to the accompanying figures and embodiments.

FIG. 1 is a schematic view illustrating a structure of a cutting device according to an embodiment of the present disclosure.

FIG. 2 is a schematic view illustrating a structure of a cutting blade assembly of a cutting device according to an embodiment of the present disclosure.

FIG. 3 is a schematic view illustrating a structure of a collection device of a cutting device according to an embodiment of the present disclosure.

FIG. 4 is a schematic view illustrating a structure of a cutter wheel of a cutting device according to an embodiment of the present disclosure.

FIG. 5 is a schematic view for a grinding to a cutted glass substrate according to an embodiment of the present disclosure.

### DETAILED DESCRIPTION OF THE PREFERRED EMBODIMENTS

To further expound the technical solution adopted in the present disclosure and the advantages thereof, a detailed description is given in a preferred embodiment of the present disclosure and the attached drawings. Obviously, the embodiments described herein are only a part of, but not all of, the embodiments of the present disclosure. In view of the embodiments described herein, any other embodiment obtained by a person skilled in the field without offering creative effort is included in a scope claimed by the present disclosure.

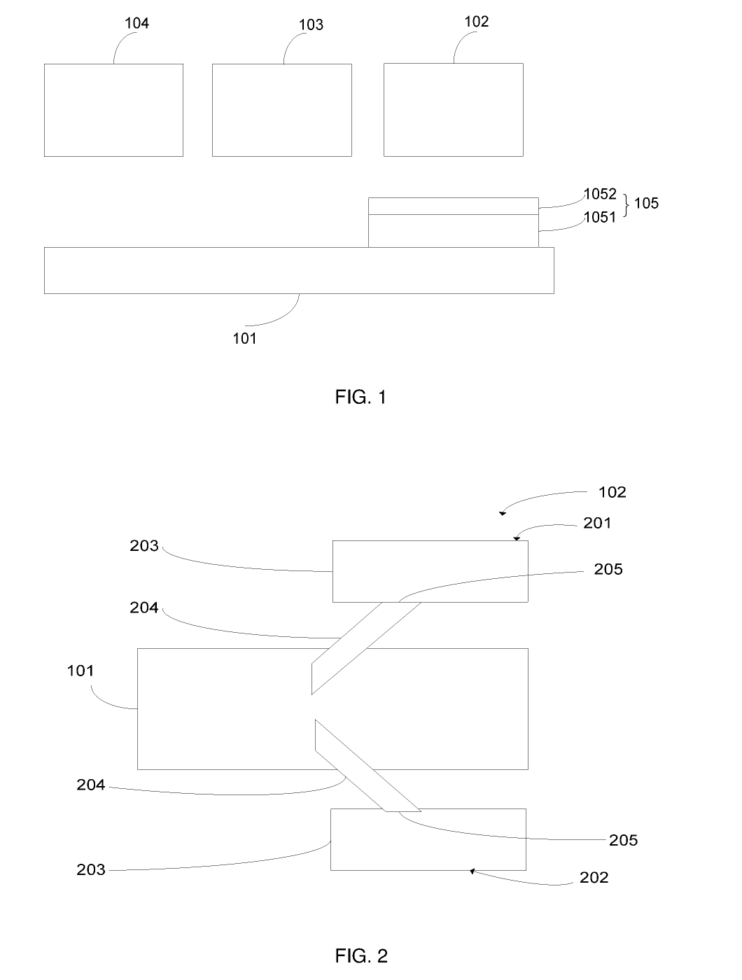

Referring to FIG. 1, a schematic view illustrating a structure of a cutting device according to an embodiment of the present disclosure is provided. Referring to FIG. 1, a cutting device of the embodiment is configured to cut a flexible substrate 105. The flexible substrate 105 includes a glass substrate 1051 and a flexible material layer 1052 disposed on the glass substrate 1051. The cutting device includes a cutting platform 101, a cutting blade assembly 102, a peeling device 103, and a cutter wheel 104. The cutting blade assembly 102, the peeling device 103, and the cutter wheel 104 are disposed above the cutting platform 101 and are sequentially disposed from right to left. The cutting platform 101 is configured to support the flexible substrate 105. The cutting blade assembly 102 is configured to cut the flexible material layer 1052. The peeling device 103 is configured to peel off a cutted flexible material layer 1052 from the glass substrate 1051. The cutter wheel 104 is configured to form a cutting mark on the glass substrate 1051 exposed outside, and the glass substrate 1051 is broken and grinded using a further process.

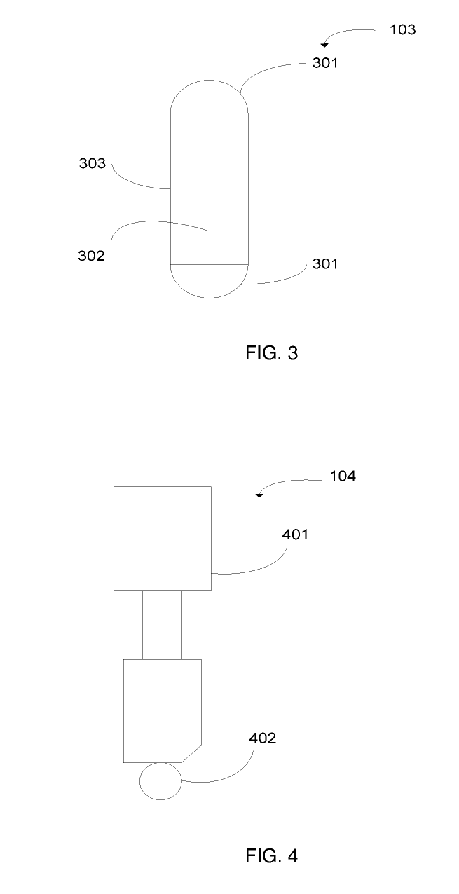

The cutting device of the embodiment of the present disclosure will be described in detail with reference to FIGS. 2, 3 and 4. FIG. 2 is a schematic view illustrating a structure of a cutting blade assembly of a cutting device according to an embodiment of the present disclosure. FIG. 3 is a schematic view illustrating a structure of a collection device of a cutting device according to an embodiment of the present disclosure. FIG. 4 is a schematic view illustrating a structure of a cutter wheel of a cutting device according to an embodiment of the present disclosure.

In conjunction with FIG. 1 and FIG. 2, the cutting blade assembly 102 includes two cutting blade groups 201 and 202 opposite to each other. Each of the cutting blade groups 201 and 202 includes a blade holder 203 and a blade 204 connected to the blade holder 203.

In detail, the two cutting blade groups 201 and 202 opposite to each other described herein can be understood that the two cutting blade groups 201 and 202 are disposed on both sides of the cutting platform 101, respectively. In FIG. 2, the cutting platform 101 and the flexible substrate 105 disposed on the cutting platform 101 are illustrated as an example. The flexible substrate 105 includes the glass substrate 1051 and the flexible material layer 1052 disposed on the glass substrate 1051. The two cutting blade groups 201 and 202 are a first cutting blade group 201 disposed on a side of the cutting platform 101 and a second cutting blade group 202 disposed on another side of the cutting platform 101, respectively. The first cutting blade group 201 and the second cutting blade group 202 have a same structure.

Further, the cutting device of the embodiment includes a cylinder (not shown) disposed on the cutting blade assembly 102. The cylinder is configured to apply a pressure to the blade holder 203 such that the blade 204 connected to the blade holder 203 is pressed into the flexible material layer 1052.

In addition, each of the cutting blade groups 201 and 202 further includes a connecting part 205. In the cutting device of the embodiment, the blade holder 203 is connected to the blade 204 via the connecting part 205. The connecting part 205 is operable to adjust a gap between the blade 204 of the first cutting blade group 201 and the blade 204 of the second cutting blade group 202. The connecting part 205 is further operable to adjust an angle between the blade 204 and the blade holder 203 such that an angle between the blade 204 and the flexible substrate 105 is adjustable. When the flexible material layer 1052 is cut, it can be adjusted as needed such that the blade 204 enters the flexible material layer 1052 at a specific angle.

In the cutting device of the embodiment of the present disclosure, the gap between the blade 204 of the first cutting blade group 201 and the blade 204 of the second cutting blade group 202 ranges between 0.5 mm to 2 mm. The angle between the blade 204 of the first cutting blade group 201 and the flexible substrate 105 and the angle between the blade 204 of the second cutting blade group 202 and the flexible substrate 105 are an acute angle such that it is easy to cut the flexible material layer 1052 and the angle between the blade 204 and the flexible material layer 1052 is an acute angle for preventing the flexible material layer 1052 from coming into contact with a groove of a grinding wheel in the further grinding process, and damage to the flexible material layer 1052 caused by the grinding wheel in the grinding process is reduced.

In conjunction with FIG. 1 and FIG. 3, the peeling device 103 includes a roller 301 and a conveyor belt 302 disposed on the roller 301. The roller 301 and the conveyor belt 302 include viscous material. The roller 301 is configured to roll on the flexible material layer 1052 such that the flexible material layer 1052 is peeled off from the glass substrate 1051 by the conveyor belt 302.

In conjunction with FIG. 1 and FIG. 4, the cutter wheel 104 include a cutting blade holder 401 and a cutting blade 402 connected to the cutting blade holder 401. The cutter wheel 104 is configured to form a cutting mark on the glass substrate 1051 exposed outside, and the glass substrate 1051 is broken and grinded using a further process.

The process of cutting the flexible substrate by the cutting device provided in the embodiment will be described in detail below.

First, the flexible substrate 105 is disposed on the cutting platform 101 such that the flexible substrate 105 is fixed to the cutting platform 101

Then, the flexible material layer 1052 is cut by the cutting blade assembly 102 disposed on the cutting platform 101. In detail, the gap between the two blades 204 and the angle between the blade 204 and the flexible substrate 105 are adjusted by the connecting part 205, and the pressure is applied to the blade holder 203 by the cylinder such that the blade 204 connected to the blade holder 203 is pressed into the flexible material layer 1052.

Then, the cutted flexible material layer 1052 is peeled off from the glass substrate 1051 by the peeling device 103. In detail, the roller 301 rolls on the cutted flexible material layer 1052 such that the flexible material layer 1052 is peeled off from the glass substrate 1051 by the conveyor belt 302, including viscous material, disposed on the roller 301.

Then, a cutting mark is formed on the glass substrate 1051 exposed outside by the cutter wheel 104.

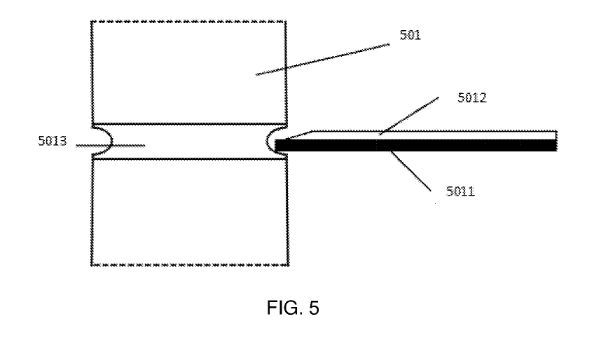

Referring to FIG. 5, a schematic view for a grinding to a cutted glass substrate according to an embodiment of the present disclosure is provided. Referring to FIG. 5, the cutted glass substrate 5011 is subjected to grinding. Since a cut angle of the cutted flexible material layer 5012 is an acute angle, a groove 5013 of a grinding wheel 501 does not come into direct contact with the cutted flexible material layer 5012, and tearing, friction, and scorching to the flexible material layer 5012 caused by the grinding process are reduced.

The cutting device of the embodiments of the present disclosure is provided by cutting the flexible material layer using the cutting blade assembly. The gap between the two blades is adjustable and the angle between the blade and the flexible material layer is adjustable such that it is easy to cut the flexible material layer and the angle between the blade and the flexible material layer is an acute angle for preventing the flexible material layer from coming into contact with a groove of a grinding wheel in the further grinding process, and damage to the flexible material layer caused by the grinding wheel in the grinding process is reduced.

The embodiment of the present disclosure further provides a cutting method for cutting a flexible substrate using the cutting device. The cutting method includes:

providing a flexible substrate on a cutting platform, the flexible substrate including a glass substrate and a flexible material layer disposed on the glass substrate;

cutting the flexible substrate;

peeling off the flexible material layer from the glass substrate after cutting the flexible material; and

forming a cutting mark on the glass substrate exposed outside.

The cutting device and the cutting method of the embodiments of the present disclosure are provided by cutting the flexible material layer using the cutting blade assembly. The gap between the two blades is adjustable and the angle between the blade and the flexible material layer is adjustable such that it is easy to cut the flexible material layer and the angle between the blade and the flexible material layer is an acute angle for preventing the flexible material layer from coming into contact with a groove of a grinding wheel in the further grinding process, and damage to the flexible material layer caused by the grinding wheel in the grinding process is reduced.

The present disclosure has been described with a preferred embodiment thereof. The preferred embodiment is not intended to limit the present disclosure, and it is understood that many changes and modifications to the described embodiment can be carried out without departing from the scope and the spirit of the invention that is intended to be limited only by the appended claims.

1. A cutting device configured to cut a flexible substrate, the flexible substrate comprising a glass substrate and a flexible material layer disposed on the glass substrate, the cutting device comprising:
a cutting platform configured to support the flexible substrate;
a cutting blade assembly configured to cut the flexible material layer, the cutting blade assembly comprising two cutting blade groups opposite to each other, each of the cutting blade groups comprising a blade holder and a blade connected to the blade holder;
a peeling device configured to peel off a cutted flexible material layer from the glass substrate, the peeling device comprising a roller and a conveyor belt disposed on the roller, the roller configured to roll on the flexible material layer such that the flexible material layer is peeled off from the glass substrate by the conveyor belt; and
a cutter wheel configured to form a cutting mark on the glass substrate exposed outside after peeling of the flexible material layer;
wherein the cutting blade assembly, the peeling device, and the cutter wheel are disposed above the cutting platform and are sequentially disposed from right to left.

2. The cutting device according to claim 1, further comprising a cylinder disposed on the cutting blade assembly, wherein the cylinder is pressed into the blade holder such that the blade is pressed into the flexible material layer.

3. The cutting device according to claim 1, wherein each of the cutting blade groups further comprises a connecting part, wherein the blade holder is connected to the blade via the connecting part, the connecting part is operable to adjust a position of the blade on the blade holder such that a gap between the two blades is adjustable, the connecting part is further operable to adjust an angle between the blade and the blade holder such that an angle between the blade and the flexible substrate is adjustable.

4. The cutting device according to claim 3, wherein the gap between the two blades ranges between 0.5 mm to 2 mm.

5. The cutting device according to claim 3, wherein the angle between the blade and the flexible substrate is an acute angle.

6. The cutting device according to claim 1, wherein the roller and the conveyor belt comprise viscous material.

7. A cutting device configured to cut a flexible substrate, the flexible substrate comprising a glass substrate and a flexible material layer disposed on the glass substrate, the cutting device comprising:
a cutting platform configured to support the flexible substrate;
a cutting blade assembly configured to cut the flexible material layer;
a peeling device configured to peel off a cutted flexible material layer from the glass substrate; and
a cutter wheel configured to form a cutting mark on the glass substrate exposed outside after peeling of the flexible material layer;
wherein the cutting blade assembly, the peeling device, and the cutter wheel are disposed above the cutting platform and are sequentially disposed from right to left.

8. The cutting device according to claim 7, wherein the cutting blade assembly comprises two cutting blade groups opposite to each other, each of the cutting blade groups comprises a blade holder and a blade connected to the blade holder.

9. The cutting device according to claim 8, further comprising a cylinder disposed on the cutting blade assembly, wherein the cylinder is pressed into the blade holder such that the blade is pressed into the flexible material layer.

10. The cutting device according to claim 8, wherein each of the cutting blade groups further comprises a connecting part, the blade holder is connected to the blade via the connecting part, the connecting part is operable to adjust a position of the blade on the blade holder such that a gap between the two blades is adjustable, the connecting part is further operable to adjust an angle between the blade and the blade holder such that an angle between the blade and the flexible substrate is adjustable.

11. The cutting device according to claim 10, wherein the gap between the two blades ranges between 0.5 mm to 2 mm.

12. The cutting device according to claim 10, wherein the angle between the blade and the flexible substrate is an acute angle.

13. The cutting device according to claim 7, wherein the peeling device comprises a roller and a conveyor belt disposed on the roller, the roller is configured to roll on the flexible material layer such that the flexible material layer is peeled off from the glass substrate by the conveyor belt.

14. The cutting device according to claim 13, wherein the roller and the conveyor belt comprise viscous material.

15. A cutting method, comprising:
providing a flexible substrate on a cutting platform, the flexible substrate comprising a glass substrate and a flexible material layer disposed on the glass substrate;
cutting the flexible substrate;
peeling off the flexible material layer from the glass substrate after cutting the flexible material; and
forming a cutting mark on the glass substrate exposed outside.
